(19) United States
(12) Patent Application Publication
(10) Pub. No.: US 2009/0066697 A1
(43) Pub. Date: Mar. 12, 2009

(54) CARICATURE TOOL

(75) Inventors: Brian D. Hanechak, Waltham, MA (US); Jeff M. Langevin, Belmont, MA (US); Slav Kulik, Mansfield, MA (US)

Correspondence Address: VISTA PRINT USA, INC.;ATTN: PATENT COUNSEL, 95 HAYDEN AVENUE, LEXINGTON, MA, 02421, US

(73) Assignee: VistaPrint Technologies Limited

(21) Appl. No.: 11/853,524

(22) Filed: Sep. 11, 2007

(51) Int. Cl. G06T 11/20

(52) U.S. Cl. 345/441

(57) ABSTRACT

Pre-designing caricatures is inflexible and hinders the design process. Accordingly, a technique for rendering a caricature made up of at least one caricature part is provided. For a subject caricature, each caricature part is sized and positioned based on the size and position of a base connection point. Each caricature part has at least one piece. Each piece is assigned a respective layer for purposes of rendering and is rendered in order according to the layer assigned to the piece. A complete caricature is assembled from each caricature part, each being sized, positioned, and ordered based on the steps of sizing, positioning, and ordering. Rendering the complete caricature in this flexible manner enables a diversity of caricatures to be rendered without having to create an entire library of possible caricatures. In this way, the design process is enhanced.

### BACKGROUND OF THE INVENTION

The widespread availability of the World Wide Web and related data processing and communication technologies have created new ways for businesses to market their products and services to their customers. Among the many new businesses that have taken advantage of the capabilities of the Web are printing service providers. Typically, these companies allow customers to access the printing service provider's web site, input customer information or other content, and place an order for custom printed products such as documents, clothing, and promotional goods. Systems that allow a client to access a printing service provider's web site, download a product template, create a customized product, and display an image of the final product to the customer are known in the prior art.

One network-based product design system is disclosed in U.S. Pat. No. 6,247,011 entitled “Computerized Prepress”. The patent discloses a document authoring tool that is downloaded from a server and runs in the client browser. The product created by the client is uploaded to the server where it is processed by a translation program into a prepress file format. Another system is disclosed in co-pending and co-owned U.S. application Ser. No. 09/557,571 entitled “Managing Print Jobs”, which is hereby incorporated by reference. The system discloses a downloadable editing tool that allows a customer to create and edit materials in the customer's browser. The system makes a number of pre-designed product templates available for customer viewing, downloading, and customizing.

In one prior system, a user selects one or more completed head designs from a library of pre-designed heads for people and animals. The user then selects a desired skin color and selects any desired additional features for each head, such as glasses and facial hair, by marking desired items on an accompanying list of available colors and features. Another prior system employs a “transparent overlay” technique using components of a fixed size such that many caricatures are undesirable because of component elements that are too large or too small in the overall design.

### SUMMARY OF THE INVENTION

The aforementioned prior systems, and well as others, lack the capability of rendering a diversity of caricatures without having to design each and every possible caricature before hand. Embodiments of the present invention, on the hand, address this and other shortcomings by providing a technique and corresponding system for rendering a caricature made up of at least one caricature part. For a subject caricature, each caricature part is sized based on the size of a base connection point. At least one caricature part is positioned based on the position of the base connection point. Each caricature part has at least one piece. Each piece is assigned a respective layer for purposes of rendering. Each piece to be rendered is ordered according to the respective layer assigned to the piece. The assembly and rendering of a given caricature into a complete caricature is accomplished by the steps of sizing, positioning, and ordering.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a computer system in which embodiments of the invention may be implemented.

FIGS. 2A-2B are block diagrams of sizing a caricature part based on the size of a base connection point, in accordance with the present invention.

FIGS. 3A-3B are block diagrams of sizing a connection point of a caricature part such that the size of the connection point and the size of a base connection point are substantially the same, in accordance with the present invention.

FIG. 4 is a block diagram of sizing an outside connection point of a caricature part such that the size of the outside connection point and size of a base connection point are substantially the same, in accordance with the present invention.

FIG. 5 is a flow diagram of an example process for rendering a caricature, in accordance with the present invention.

### DETAILED DESCRIPTION OF THE INVENTION

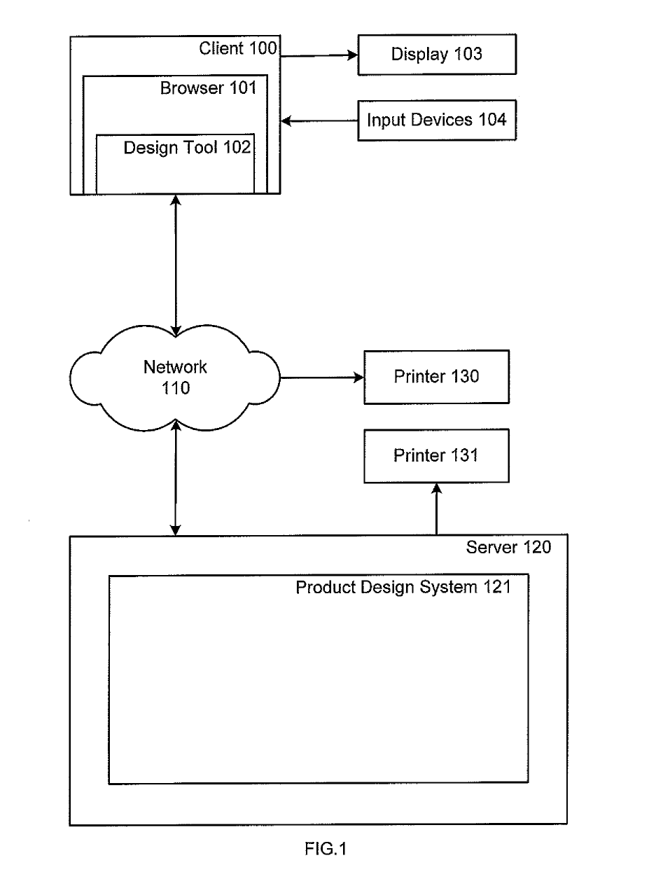

FIG. 1 illustrates an example client/server system with which embodiments of the present invention may be employed. In an example embodiment, client 100 is a personal computer equipped with the usual complement of features and peripherals, including display device 103 and input devices 104, including a keyboard and a mouse. Client 100 is running browser program 101, such as MICROSOFT EXPLORER from MICROSOFT CORPORATION or NETSCAPE from NETSCAPE COMMUNICATIONS. Client 100 could be any device, such as a portable computer, tablet computer, kiosk, dedicated terminal, or Web-enabled telephone that is capable of running browser software and supporting communication with server 120, Client 100 communicates with server 120 via network 110. Network 110 may be, for example, the World Wide Web, but could be any intranet, extranet, or other network.

Server 120 is a computer system having a universal resource locator and adapted to be accessed by geographically dispersed clients over network 110. While shown in FIG. 1 as a single unit, it will be understood that server 120 may be comprised of a plurality of individual processors or computers, data storage units, and other equipment, which may be either in the same or in different geographical locations, operating cooperatively so as to support a commercial Web-based enterprise and to provide associated computational, informational, and electronic commerce support to the enterprise's customers. Server 120 is running product design system 121. In a convenient embodiment, system 121 allows the user of client 100 to design a variety of custom products for subsequent printing. Upon completion of the order and satisfaction of all other conditions, such as receipt of payment and availability of the printing system, product design system 121 will either produce the customer's product locally on printer 131 or transmit the product design over network 110 to remote printer 130 for production. Alternatively, product design system 121 could make the electronic product image available to client 100 and leave the arrangements for the actual production of the finished product to the client.

When server 120 is initially accessed by client 100, the client is provided with the system 121 home page. The home page provides information about the products and services offered by product design system 121. The home page also provides various links by which the user may navigate to other portions of the site. The design and operation of electronic commerce Web sites and the processes and techniques for exchanging commands and data between a client and a server are well known in the art. In an example embodiment, the products offered by system 121 include, for example, business cards, postcards, letterhead, and brochures.

As mentioned above, client/server systems providing a client with the ability to design custom documents for subsequent printing are known in the art. The present invention described below relates to a novel capability suitable for incorporation into such a product design system. The capability allows the rendering or otherwise depiction of a caricature, which may then be later, incorporated into the product.

As will be clear from the following discussion, in its broadest application, the present invention relates to the system and method for rendering the caricature regardless of the print medium or, indeed, regardless of whether the caricature is intended for printing at all, such as a caricature rendered for use as a screensaver, an e-mail attachment, or other electronic use.

A caricature is a simple drawing or cartoon. A complete caricature may be rendered from one or more caricature parts. In other words, a complete caricature is made up of one or more caricature parts. For example, a complete caricature of a human head is made up of caricature parts divided into the following broad categories: head, eyes, nose/mouth, hair (facial hair), and add-ons (accessories), such as glasses, hats, and earrings. These broad categories may be further divided into subcategories. For example, the category of hair is divided for presentation into the subcategories of male hairstyles, female hairstyles, and children's hairstyles. Each subcategory is associated with a set of related caricatures. For example, the subcategory of male hairstyles includes a selection of caricatures depicting various male hairlines, hair of various lengths and thicknesses, and so forth.

In an example application of the present invention discussed below, the system (or tool) provides a technique for rendering a complete caricature of a human head from one or more caricature parts, such as hair, eyes, nose, and mouth. The rendered complete caricature may then be later incorporated into a product, such as a printed document, or downloaded in electronic form. By rendering generalized facial and hairstyle types together along with selected skin and hair colors, facial hair, glasses, and other appropriate accessories, the rendered complete caricature has general appearance attributes in common with an individual known to a user of the present caricature rendering tool.

In contrast to a caricature of a human head, some caricatures are made up of one caricature part, for example, a caricature of a fish or a dog. For such caricatures, rendering a complete caricature from multiple caricature parts may not be necessary for the complete caricature to have the general appearance attributes in common with an animal (i.e., pet) known to a user. As will be discussed below, embodiments of the present invention are applicable to rending both caricatures made up of one caricature part and those caricatures made up of more than one caricature part.

In an example embodiment, caricatures and caricature parts are rendered using well known vector artwork generation tools employing lines and Bézier curves. Other techniques known in-the art could be employed.

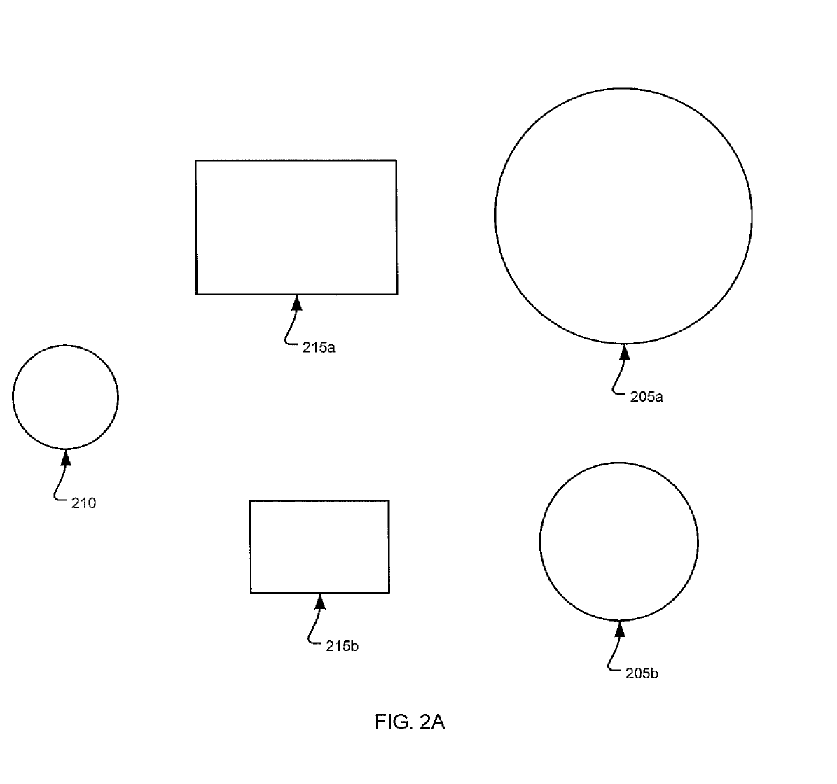

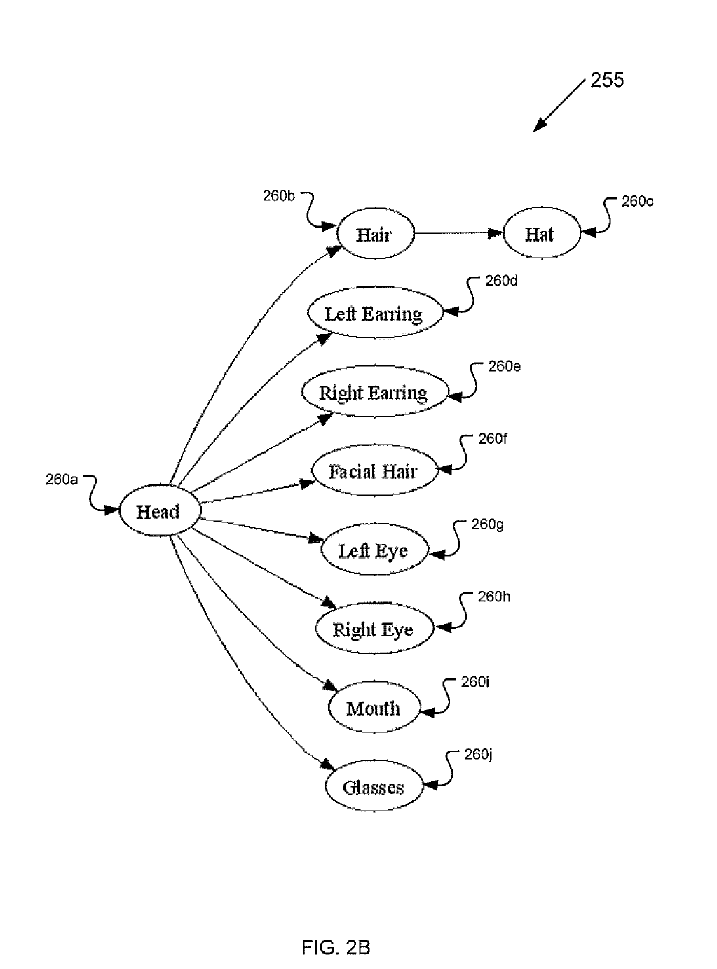

In FIG. 2A, a caricature 205a or 205b may be made up of a caricature part 210. For the subject caricature 205, the caricature part 210 is sized based on the size of a base connection point 215a or 215b to render a caricature of the appropriate size. In this example, the caricature part 210 is sized based on a first base connection point 215a and a second base connection point 215b. Because the size of the first base connection point 215a is larger than the size of the second base connection point 215b, the rendered caricature 205a is larger than the rendered caricature 205b. In this way, by varying the size of a base connection point and basing the size a caricature part on the size of the base connection point, a variety of differently sized caricature parts are possible when rendering a caricature.

Sizing a caricature part based on a size of a base connection point is contrasted with simply creating a caricature part of different sizes to be used in rendering a caricature. Rather then having a collection of various sized caricature parts, there is one caricature part of an indefinite and variable size. Rendering a caricature in this manner may be advantageous. For example, it is not necessary to determine a priori all possible sizes of a caricature part. Additionally, it is not necessary to store all the possible sizes of the caricature part. As such, rendering a caricature by sizing a caricature part based on the size of a base connection point enables design flexibility and economizes resources needed to render a caricature.

Furthermore, rendering a caricature by sizing a caricature part based on the size of a base connection point reduces both development and implementation efforts. For example, rather than being concerned with creating all possible sizes for a given caricature part, the concern is reduced to just sizing a base connection point. In this way, resizing a caricature part, and thus a caricature, involves resizing a base connection point and not creating another caricature part.

In addition to sizing, at least one caricature part is positioned based on the base connection point. Similar to sizing, positioning a caricature part based on a base connection point may be advantageous. This technique requires neither determining all possible positions beforehand nor storing all the possible positions.

Because a caricature part is sized and positioned based on a base connection point, it may be said that the base connection point defines or otherwise dictates the sizing and positioning of the caricature part when rendering a complete caricature. Although FIG. 2A illustrates the base connection points 215a and 205b being rectangles, other shapes having a center point, and known height and width, for example, an ellipse, may be employed. One of ordinary skill in the art will readily recognize that the principles of the present invention of sizing and positioning a caricature part based on a base connection point applies to base connection points of other shapes and designs.

As will be made clear by the following description, a caricature part whose size and position is determined or otherwise dictated by the sizing and positioning of a base connection point, may be said to be “connected” to the base connection point. Accordingly and for the sake of convenience, a caricature part connected to a base connection point refers to a caricature part whose size and position is determined by the sizing and positioning of the base connection point. As will be described in greater detail below, a caricature part may be connected to a base connection point directly or indirectly. That is to say, the size and position of a caricature part may be based either directly or indirectly on the size and position of a base connection point.

In a caricature made up of one caricature part, the caricature part is connected to the base connection point. As such, sizing and positioning the base connection point causes the caricature part, and thus the caricature, to be sized and positioned accordingly.

In a caricature made up of more than one caricature part, a caricature part may be connected to the base connection point, i.e., directly connected. Alternatively, a caricature part may be connected to another caricature part, which in turn is connected to the base connection point i.e., indirectly connected. To illustrate directly connected and indirectly connected consider the example illustrated in FIG. 2B.

In FIG. 2B, an example caricature 255 is made up of head part 260a in combination with such additional caricature parts 260b-j, as are desired by the user. Each caricature part 260a-j, contains some number of connection points connecting the caricature part 260a-j to either another caricature part 260a-j or to a base connection point.

Generally, a first caricature part contains a first connection point to a second caricature part. Reciprocally, the second caricature part contains second connection point to the first caricature part. For example, a head 260a contains a connection point to a hair 260b and the hair 260b contains a connection point to the head 260a. In this way, the head 260a is connected to the hair 260b and the hair 260b is connected to the head 260a.

The connection point of the head 260a may be considered to be a base connection point, and as such, sizing and positioning the base connection point (e.g., by resizing and/or repositioning the head 260a) causes the size and position of the hair 260b to change.

It is important to note that a caricature part is sized and positioned based on a base connection point and not another caricature part. As such, a caricature part may be sized and positioned even when there are no other caricature parts, as such is the case in a caricature made up of one caricature part. Moreover, a caricature part is sized and positioned independent of the size and position of another caricature part.

Continuing to refer to FIG. 2B, note that a hat 260c is connected to the head 260a indirectly. That is to say, the hat 260c does not have a connection point to the head 260a and the head 260a does not have a connection point to the hat 260c. However, because the hat 260c is directly connected to the hair 260b, which in turn is directly connected to the head 260a, sizing and positioning the base connection point of the head 260a causes the size and position of not only the hair 260b to change, but also the hat 260c. In this way, a caricature of a head having a large head has correspondingly large hair and hat. Conversely, a caricature of a head having a small head has appropriately sized small hair and hat.

Not everyone, of course, has hair. When the hat 260c is selected by a user when no hair 260b has been previously selected, the system automatically renders a hair 260b part that is not visible, but has the requisite connection point required for the chosen hat 260c.

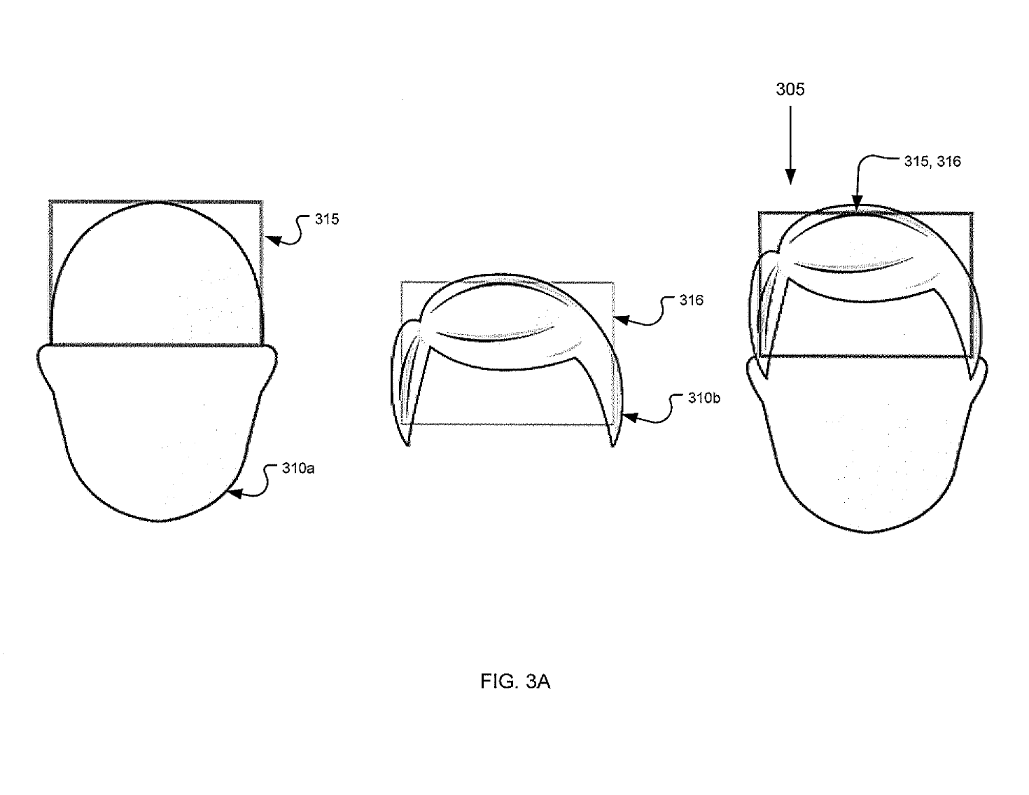

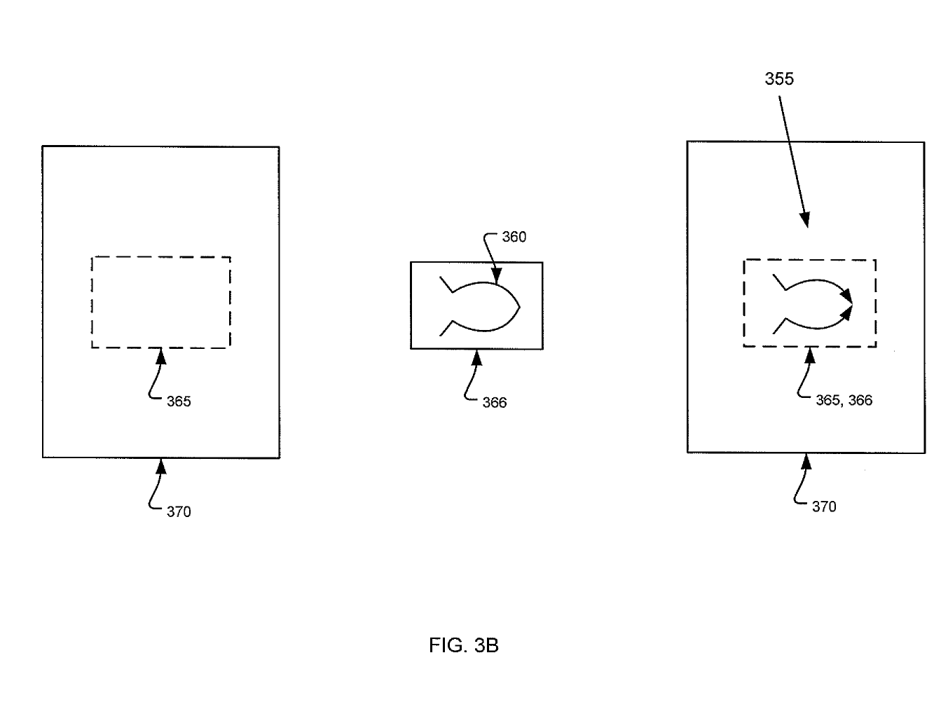

In FIG. 3A, an example caricature of a human head 305 is made up of a first caricature part (head) 310a and a second caricature part (hair) 310b. The head 310a contains a base connection point 315 to the hair 310b. The hair 310b contains a connection point 316 to the head 310a. The connection point 316 is sized such that the base connection point 315 and the connection point 316 have substantially the same size. In this way, increasing the size of the base connection point 315 results in a corresponding and equivalent increase in the size of the connection point 316, and thus the hair 310b. Similarly, decreasing the size of the base connection point 315 results in a corresponding and equivalent decrease in the size of the connection point 316, and thus the hair 310b.

In an alternative embodiment, a connection point is sized such that a relationship between the size of the connection point and the size of a base connection point is defined by a fixed ratio. For example, increasing the base connection point 315 by a factor of one results in an increase in the connection point 316, and thus the hair 310b by a factor of two. In this example, the size of the connection point is increased by a fixed ratio of two to one.

Again, it is important to note that the connection point 316, and thus the corresponding hair 310b, is sized according to the base connection point 315, and not the actual size of the head 310a.

Similarly, the connection point 316 is positioned such that the base connection point 315 and the connection point 316 coincide or otherwise occupy the same space.

In FIG. 3B, an example caricature of a fish 355 is made up of one caricature part 360, namely, the fish. Unlike the previous example, there is no caricature part containing a base connection point 365. For the sake of convenience and for purposes of description, the base connection point 365 is referred to as a “container.” The container 365 may be part of, for example, a printed document 370, in instances where the rendered complete caricature is to be printed. Alternatively, the container 365 may be part of a virtual canvas, such as a bitmap created using MICROSOFT GDI+ technology, in instances where the rendered complete caricature is to be downloaded or previewed by a customer using the present caricature design tool. The container 365, however, is not necessarily a visible component (denoted by dashed lines) of either the printed document 370 or the virtual canvas. More appropriately, the container 365 instructs or otherwise determines how a caricature should be sized (or scaled) and/or where a caricature should be positioned (or placed) with respect to the container 365.

As before, the container 365 connects to the fish caricature part 360. The fish caricature part 360 has an “outside” connection point 366 to the printed document 370 (or a virtual canvas). In this way, the fish caricature part 360 and the printed document 370 are connected. In other words, the caricature part 360 is “attached” to the printed document 370. As such, sizing and positioning the container 365 causes the outside connection point 366 and thus, the fish caricature part 360, to be sized and positioned accordingly.

In a convenient embodiment, an outside connection point scales uniformly, but does not stretch (i.e., scale non-uniformly). For example, if an outside connection point of a head caricature part has a size of 100×100 pixels, and a container of a document or virtual canvas has a size of 200×300 pixels, the outside connection point (and thus the head caricature part) will be scaled or otherwise sized by a factor of two and the outside connection point will be centered or otherwise positioned within the 200×300 pixels space defined by the container.

In yet another convenient embodiment, a caricature part making up a caricature does not extend beyond an outside connection point. As such, every point of the rendered complete caricature (after all other caricature parts are sized, positioned, ordered, and assembled) ends up inside the outside connection point. This “rule” may be advantageous because it is known that a rendered complete caricature will not extend beyond the container, and thus a document or virtual canvas.

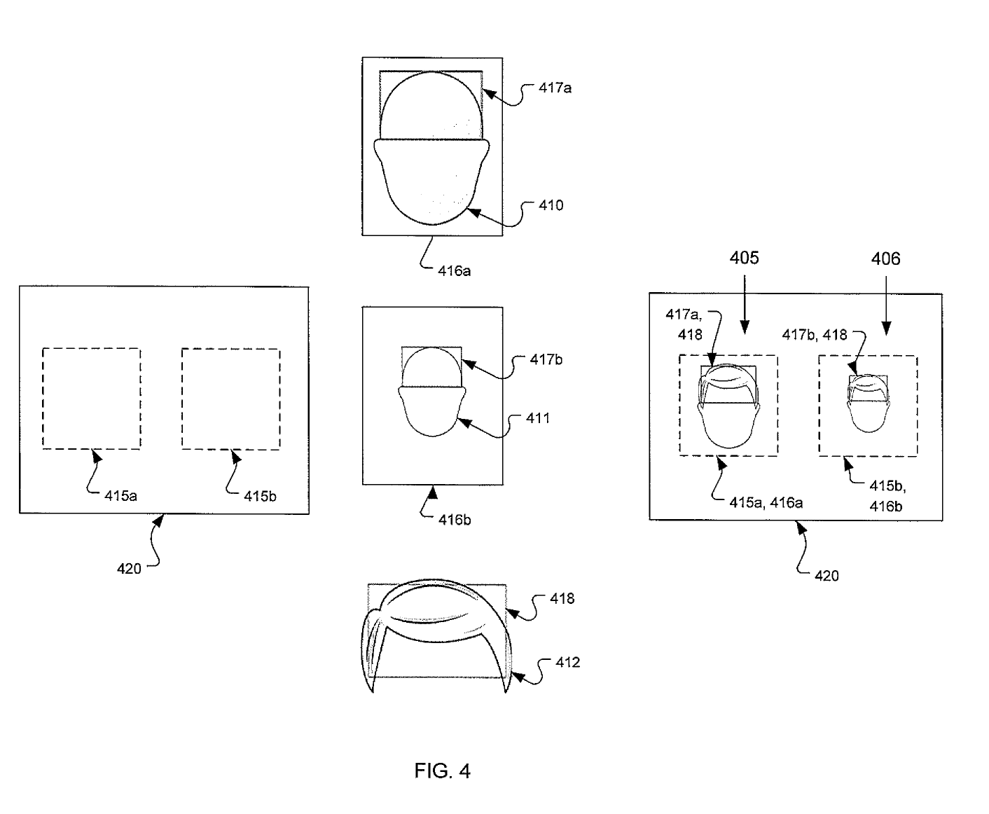

It should be readily apparent that the above description of the container 365 and the outside connection point 366 also applies to caricatures made up of more the one caricature part. Consider the example illustrated in FIG. 4.

In FIG. 4, an example caricature of an adult head 405 and an example caricature of a child head 406 are rendered for print onto a printed document 420 (e.g., a holiday card). The caricature of the adult head 405 is made up of an adult head caricature part 410 and a hair caricature part 412. The caricature of the child head 406 is made up of a child head caricature part 411 and the hair caricature pail 412. Adult and child head caricature parts of varying sizes and shapes are provided to provide the user with a range of choices.

FIG. 4 further illustrates containers 415a and 415b being part of the printed document 420. As described above, the containers 415a and 415b are not necessarily visible components (denoted by dashed lines) of the printed document 420. Rather, the containers 415a and 415b instruct how the caricature of the adult head 405 and the caricature of the child head 406 are sized and positioned with respect to the containers 415a and 415b. Note, the containers 415a and 415b are of the same size and position, and as such, either caricatures 405 or 406 may be rendered with respect to either containers 415a or 415b. Furthermore, caricatures of either two adult heads or of two child heads may all be rendered similar to rendering an adult head and child head.

The adult head 410 contains an outside connection point 416a to any container, such as container 415a or 415b. The adult head 410 also contains a connection point 417a to the hair 412. The child head 411 contains a respective outside connection point 416b to either container 415a or 415b. The child head 411 also contains a respective connection point 417b to the hair 412. As described previously, the connection point 417a and the respective connection point 417b may be considered to be base connection points for purposes of connecting (i.e., for purposes of sizing and positioning) the adult head 410 and the hair 412, and child head 411 and the hair 412 are connected, respectively.

To make the caricature of the adult head 405 larger relative to the caricature of the child head 406, in one implementation as shown, the adult head part 410 takes up most of the space inside the outside connection point 416a. The child head part 411, on the other hand, takes up less space inside the respective outside connection point 416b relative to the space taken by the adult head part 410. Alternatively, the respective outside connection point 416b is made larger relative to the outside connection point 416a.

The outside connection points 416a and 416b are sized and positioned based on the size and position of the containers 415a and 415b (recall that a container is base connection point). Because the adult head part 410, with respect to its outside connection point 416a, is larger than the child head part 411, with respect to its respective outside connection point 416b; and because the size and position of the containers 415a and 415b are the same, the rendered complete caricature of the adult head 405 is larger than the rendered complete caricature of the child head 406.

Moreover, because the connection point 417a (adult head) to the hair 412, with respect to the outside connection point 416a, is larger than the respective connection point 417b (child head) to the hair 412, with respect to the respective outside connection point 416b; the complete caricature of the adult head 405 is rendered with “adult-sized” hair while the complete caricature of the child head 406 is rendered with “child-sized” hair. As such, rendering a complete caricature of a human head in the above-described manner need not, for example, involve creating separate hair caricature parts for heads of differing head sizes and head shapes. While the example of hair is discussed and depicted by way of illustration, it will be appreciated that other component parts 260c-260j are similarly sized and positioned.

In addition to a connection point, each caricature part is made up of at least one piece or portion. Each piece is assigned a respective layer for purposes of rendering a complete caricature. The layer specifies an order in which to render a piece for a given caricature part. As such, in addition to sizing and positioning a caricature part based on a base connection point, rendering a complete caricature also involves ordering each piece to be rendered according to a layer assigned to each piece.

For example, in a convenient embodiment, each piece assigned to a “back” layer is rendered before rendering each piece assigned to a “middle” layer. Each piece assigned to the middle layer is then rendered before rendering each piece assigned a “front” layer. In this way, a piece or portion of the first caricature part, such as hair, is rendered behind a second caricature part, such as a head. Another piece of the first caricature part is then rendered in front of the second caricature part, but behind a third caricature part, such as glasses. And yet another piece of the first caricature part is then rendered in front of the third caricature part.

For example, a first caricature part hair has a long strand piece, a side piece, and a bangs piece. The long strand piece is assigned to a back layer and is rendered behind the second caricature part, head. The side piece (another piece of the first caricature part the hair) is assigned to a middle layer and is rendered in front of the head (second caricature part) but behind a third caricature part, glasses. The bangs piece of the hair (first caricature part) is assigned to a front layer and is rendered in front of the glasses (third caricature part).

Accordingly, it may be said that each piece has a predetermined position in a stack. Moreover, the ordering of each piece to be rendered may be further described as positioning each piece of a given caricature part according to a layer assigned to each piece.

From the viewpoint of a user using the present caricature rendering tool, a complete caricature is rendered from a number of caricature parts or elements that make conceptual sense to the user as a single part, such as head, hair, glasses, facial hair, etc. However, in implementation, some caricature parts may be a set of pieces. In a convenient embodiment, a set up pieces share a common connection point connecting, for example, the pieces to another caricature part. As such, the size and position of each piece making up a caricature part is based on the size and position of a base connection point.

So far, rendering a complete caricature involves sizing and positioning a caricature part based on a base connection point, and ordering pieces of the caricature part based on layers assigned to each piece. Rendering the complete caricature further involves assembling each caricature part, each being sized, positioned, and ordered based on the sizing, positioning, and ordering. It is important to note that because the processes of sizing, positioning, and ordering are applicable both to caricatures made up of one caricature part and to caricatures made up of more than one caricature part, the process of assembling also applies to both types of caricatures.

In a convenient embodiment, each caricature part, each being sized, positioned, and ordered based on the process of sizing, positioning, and ordering, is assembled into a complete caricature in a substantially real-time manner. For example, in an event there is a change in the size and/or position of a connection point or the ordering of a piece of a caricature part, such a change is evident without delay in the rendered complete caricature. Presented differently, the rendered complete caricature is continually updated and represents an assembly of caricature parts whose state of being sized, position, and ordered is current. In this way, a user of the present caricature rendering tool, is presented with a current complete caricature. Rendering a caricature in this manner may be advantageous because modifications made to the caricature are based on the caricature as currently displayed and continually updated, thus in near real-time interaction with the user.

In another convenient embodiment, rendering a caricature includes the additional process of selecting a version of a given caricature part having a first version and at least one second version, based on the presence or absence of a certain caricature part in a rendered complete caricature. Consider the example of rendering a caricature of a human head with hair wearing a hat.

Everyday experience dictates that the hat is not simply placed on top of the hair, but rather some portion(s) of the hair are tucked inside under the hat. In this example embodiment, to effectively render this involves multiple versions of hair, namely, a version of hair for the hat and a version for no hat. In this way, a specific version of hair is selected based on the presence or absence of the hat in the rendered complete caricature. Rendering a caricature in this manner may be advantageous because the various hairstyles may be rendered while accommodating various hairstyles, for example, a small baseball cap worn over big bushy hair.

In yet another convenient embodiment, rendering a caricature includes the additional process of presenting previews of a given caricature part in the context of a certain caricature part. For example, previews of various hairstyles on a certain type of head are presented. Rendering a caricature in this manner aids or otherwise facilitates user's selection and design process by presenting previews of what possible complete caricatures might look like.

In addition to a connection point, each caricature part may define one or more color scheme types that may be applied to the caricature part. In one embodiment, for each caricature part, spot colors mark places where the color scheme colors should be used. The spot colors are then substituted for the colors of the color scheme when rendering the complete caricature.

In a convenient embodiment) rendering a caricature includes the additional process of coloring each caricature part according to a color scheme having at least a first, second, and third color. For example, a hair caricature part references to a “hair” color scheme type. The hair color scheme type specifies that the hair color schemes each have three colors. As such, three different spot colors are used when designing hair (referred to as “Hair Color 1,” “Hair Color 2,” and “Hair Color 3”).

The present caricature rendering tool presents several different choices of hair colors. Each of these choices is a scheme which specifies specific “process” color values (i.e., cyan, magenta, yellow, and key (Black) or CMYK) for each of the three hair spot colors. When a user selects a choice of hair color (e.g., “Hair Color 2”), the hair spot color is used for the main part of most of the hair while the other colors are a darker “shadow” color and a lighter “highlight” color.

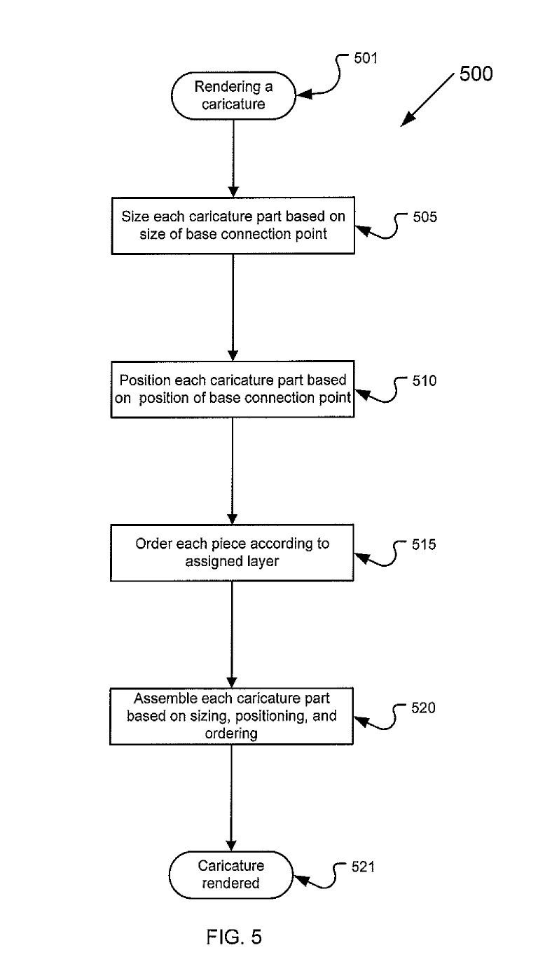

FIG. 5 is an example process 500 implementing the foregoing. Design tool 102 of FIG. 1 executes the process 500. Example process 500 starts (501) rendering a caricature made up of at least one caricature part in response to user interaction. The process 500 for a subject caricature, sizes (505) each caricature part based on the size of a base connection point. The process 500 positions (510) at least one caricature part based on the position of the base connection point. Each caricature part has at least one piece. Each piece is assigned a respective layer for purposes of rendering. The process 500 orders (515) each piece to be rendered according to the layer assigned to each piece. The process 500 assembles (520) each caricature part, each being sized, positioned, and ordered based on the steps of sizing (505), positioning (510), and ordering (515) into a complete caricature. The process 500 ends (521) with the complete caricature rendered.

While this invention has been particularly shown and described with references to example embodiments thereof, it will be understood by those skilled in the art that various changes in form and details may be made therein without departing from the scope of the invention encompassed by the appended claims.

An example embodiment of the present invention has been shown and described and various alternative methods and structures for other embodiments have been mentioned, but the foregoing description is to be considered in all aspects as illustrative rather than restrictive. While the system or tool has been described in the context of a client/server application, the invention could be embodied as a computer application for running entirely on a single computer. Rendered complete caricatures could be incorporated into a wide variety of materials intended to be printed on paper, such as business cards, postcards, brochures, letterhead, reports, books and advertising. The embodiments of the present invention are not limited to paper products, but could also be readily employed with clothing, promotional goods, and other products constructed of plastic, wood, cloth, glass or any other substrate suitable for printing by any process. Complete caricatures rendered according to the invention could also be employed in digital form without printing, such as a screen saver, e-mail attachment, or chat image. The scope of the invention is as indicated in the following claims and all equivalent methods and apparatus.

It should be understood that the flow diagram may include more or fewer elements, be arranged differently, or be represented differently. It should be understood that implementation may dictate the flow diagram and the number of flow diagrams illustrating the execution of embodiments of the invention.

Further, it should be understood that elements of the flow diagram described above may be implemented in software, hardware, or firmware. In addition, the elements of the flow diagram described above may be combined or divided in any manner in software, hardware, or firmware. If implemented in software, the software may be written in any language that can support the embodiments disclosed herein. The software may be stored on any form of computer readable medium, such as random access memory (RAM), read only memory (ROM), compact disk read only memory (CD-ROM), and so forth. In operation, a general purpose or application specific processor loads and executes the software in a manner well understood in the art.

What is claimed is:

1. A computer implemented method for rendering a caricature made up of at least one caricature part, the method comprising:
for a subject caricature, sizing each caricature part based on the size of a base connection point;
positioning at least one caricature part based on the position of the base connection point;
each caricature part having at least one piece, each piece assigned a respective layer for purposes of rendering;
ordering each piece to be rendered according to the layer assigned to the piece; and
assembling each caricature part, each being sized, positioned, and ordered based on the steps of sizing, positioning, and ordering into a complete caricature.

2. The method of claim 1 wherein sizing includes sizing a connection point of the at least one caricature part based indirectly on the size of the base connection point.

3. The method of claim 1 wherein sizing includes sizing a connection point of the at least one caricature part such that the connection point and the base connection point are substantially the same size.

4. The method of claim 1 wherein sizing includes sizing a connection point of the at least one caricature part such that a relationship between the size of the connection point and the size of the base connection point is defined by a fixed ratio.

5. The method of claim 1 wherein positioning includes positioning a connection point of the at least one caricature part based indirectly on the position of the base connection point.

6. The method of claim 1 wherein positioning includes positioning a connection point of the at least one caricature part such that the connection point substantially coincides with the base connection point.

7. The method of claim 1 wherein ordering includes:
rendering each piece assigned to a back layer before rendering each piece assigned to a middle layer; and
rendering each piece assigned to the middle layer before rendering each piece assigned to a front layer.

8. The method of claim 1 wherein ordering includes positioning each piece of a given caricature part according to the layer assigned to the piece.

9. The method of claim 8 wherein positioning includes positioning each piece of the given caricature part based on a common connection point shared amongst the pieces.

10. The method of claim 1 wherein assembling includes assembling in a substantially a real-time manner each caricature part, each being sized, positioned, and ordered based on the step of sizing, positioning, and ordering into the complete caricature.

11. The method of claim 1 further comprising selecting a version of a given caricature part, having a first version and at least one second version, based on the presence or absence of a certain caricature part in the complete caricature.

12. The method of claim 1 further comprising presenting previews of a given caricature part in the context of a certain caricature part.

13. The method of claim 1 further comprising coloring each caricature part according to a color scheme having at least a first, second and third color.

14. A caricature rendering program for rendering a caricature made up of at least one caricature part, configured to run in a server computer operatively connected to a client computer, the client computer having a display device and a user data input device, the program comprising:
for a subject caricature, means for sizing each caricature part based on the size of a base connection point;
means for positioning at least one caricature part based on the position of the base connection point;
each caricature part having at least one piece, each piece assigned a respective layer for purposes of rendering;
means for ordering each piece to be rendered in accordance with the layer assigned to the piece; and
means for assembling each caricature part, each being sized, positioned, and ordered based on the steps of sizing, positioning, and ordering into a complete caricature.

15. A computer program embodied on one or more computer readable media and configured to run in a client computer to enable the user of the client computer to render a caricature made up of at least one caricature part, the client computer having a display device and a data input device and being connected to a server, the program comprising:
for a subject caricature, program code for sizing each caricature part based on the size of a base connection point;
program code for positioning at least one caricature part based on the position of the base connection point;
each caricature part having at least one piece, each piece assigned a respective layer for purposes of rendering;
program code for ordering each piece to be rendered in accordance with the layer assigned to the piece; and
program code for assembling each caricature part, each being sized, positioned, and ordered based on the steps of sizing, positioning, and ordering into a complete caricature.
